(19) United States
(12) Patent Application Publication
(10) Pub. No.: US 2019/0357625 A1
(43) Pub. Date: Nov. 28, 2019

(54) MOTORCYCLE HELMET PROVIDING COOL AND CLEANING AIR

(71) Applicants: CHIH-CHIEH CHEN, Taipei (TW); AI-LUN JIAN, Taipei (TW); SHENG-HSIU HUANG, Taipei (TW); CHIH-WEI LIN, Taipei (TW)

(72) Inventors: CHIH-CHIEH CHEN, Taipei (TW); AI-LUN JIAN, Taipei (TW); SHENG-HSIU HUANG, Taipei (TW); CHIH-WEI LIN, Taipei (TW)

(21) Appl. No.: 15/987,853

(22) Filed: May 23, 2018

(51) Int. Cl. A42B 3/28; A42B 3/18; A42B 3/12; A42B 3/16; A62B 7/10; A62B 18/04; A62B 23/02

(52) U.S. Cl. CPC A42B 3/286; A42B 3/285; A42B 3/283; A42B 3/185; A62B 23/02; A42B 3/16; A62B 7/10; A62B 18/04; A42B 3/12

(57) ABSTRACT

A motorcycle helmet providing cool and cleaning air may comprise a helmet body, having a window opening and a wearing opening, wherein two sides of the window opening pivotally connect to a goggle; the goggle can pivot to the window opening and seals it; the wearing opening is installed a first connecting device around; there is a ventilation hole on an opening position on the helmet body or the goggle; an ventilation tube with one end connected to the ventilation hole; a PAPR-typed air supplier connected to the other end of the ventilation tube, for providing external air which has been screened to remove particulate matters to the helmet body through the ventilation tube; and a guiding towel made of wind-proof materials, wherein a top end of the guiding towel has a second connecting device and the second connecting device is removably connected to the first connecting device.

### FIELD OF THE INVENTION

The present invention relates to a motorcycle helmet. More particularly, the present invention relates to a motorcycle helmet which is able to provide cool and clean air.

### BACKGROUND OF THE INVENTION

According to a recent report of the Taiwan Environmental Protection Agency, the concentration of particulate matters (PM2.5) of locomotive gas emissions may be as high as 730 μg/m³ depending on vehicle brand and model. When waiting for a traffic light, the concentration of particulate matters exposed by the motorcycle riders can reach 460 μg/m³, significantly higher than other commuters. This is quite unfavorable to the health, especially the respiratory system and the closely related circulation system. In order to settle these problems, motorcycle riders generally wear filtering face piece that can filter particulate matters, such as N95 masks, to protect the lungs from inhaling excessive harmful substances. In addition to the discomfort of air resistance, the use of filter mask also increases the dead space, and therefore, the wearer has to breathe harder to compensate for the oxygen intake. Another problem of the use of filtering face piece is that it might interfere the use of safety helmet, especially the full face helmet.

Troubles faced by the motorcycle riders are not only respiratory hazards. Transportation regulations compulsorily require motorcycle riders to wear helmets when riding. This requirement inevitably increases the mass loading on the neck and the heat accumulated around the head is not easy to dissipate. Meanwhile, sweat of the motorcycle riders absorbed by the helmets has lingering bad smell. The motorcycle helmet can be classified as full-faced style, jet style, semi-jet style and half-faced style. They all work to reduce the head injury in the event of a traffic accident. However, the risk of head injury when wearing a half-faced style helmet is 2.57 times that of a full-faced helmet (Yu et al. 2011), indicating the strength of full face helmet. Due to weather conditions tropical area, such as Taiwan, especially in the summer, it often makes the motorcycle riders sacrifice safety of full face helmet and choose, for comfort, jet style, semi-jet style and/or half-faced style helmets. Although many manufacturers improve the structure of their helmets, trying to solve the problem of hot issue in the helmets by guiding the incoming air flow through the top of the full face helmet, the present invention discloses a more active way to improve comfort of the helmets, and at the same time, to provide respiratory protection against particulate matters for motorcycle riders. With the present new design, safety of the full-faced helmets will not be traded for discomfort. It is a win-win invention.

Meanwhile, considering hazards of particulate matters and discomfort of conventional helmets, there are some prior designs for proper solutions. China utility model patent No. 2052625U provides a dust-proof and cold-proof helmet device for bicycle riders or pedestrians. A feature of the device is that a piece of sealing cloth is connected to the lower end of the helmet. When the air pollution is serious or the weather is cold, the wearer can tighten the zipper on the sealing cloth. Breathing air is purified by the filtering sponge, which can effectively prevent dust and cold wind. Although the patent uses the sealing cloth and the filtering sponge to achieve air filtration, the efficiency data is limited. In addition, inhaled heat and carbon dioxide accumulation inside the helmet cannot be effectively exhausted. It provides no really helpful solution for the motorcycle riders.

Alternatively, US patent No. 2017/0136268 provides a personal powered air respirator. The powered air respirator includes a helmet, a backpack, a fan, a filter for inputting air and a soft tube for guiding the air to the helmet. Advantages of the patent are dust-filtered air is sent to the helmet by the fan and the helmet can be changed to a proper type. However, using the product made according to this patent when traveling on road, or in a traffic jam is hardly enough to block contaminated air convection from the lower side of the neck of a motorcycle rider. It is inevitably to inhale dirty air.

At last, ROC utility model patent No. M518005 discloses a dust-proof helmet. It includes a helmet body, an air inlet and a blower and an air outlet. The helmet body has a space to accommodate the blower. The air inlet opening is located below a lower side of the helmet. A window is formed in front of the helmet body and connects a wearable space. The air outlet is installed at a brink of the window and connects to the wearable space. The suction device is accommodated inside the accommodating portion and has a fan and a tube. The fan has an exhausting side connected to the air outlet and a suction side. The tube has opposite ends connecting to the suction side and the suction opening, respectively. Structural design of the utility model is able to prevent dusts or particulate matters in the air and water from entering the wearable space. It can also maintain clean air inside the helmet body. However, due to a poor design of the air flow path in the helmet body, the accumulated waste heat is difficult to exhaust.

Since the prior arts are not able to solve the problems when current motorcycle helmets are used, there is a need to develop an innovative full-faced motorcycle helmet providing cool and clean air. This helmet can solve the problem of particulate matters when the motorcycle riders breathe. Meanwhile, the heat accumulated around the head can be effectively exhausted, further preventing the motorcycle riders from sweating that causes lingering bad smell.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to settle the problems mentioned above, a motorcycle helmet providing cool and clean air is disclosed. The motorcycle helmet includes: a helmet body, having a window opening and a wearing opening, wherein two sides of the window opening are pivotally connected to a goggle, the goggle is able to pivotally rotate to the window opening and seal the window opening, the wearing opening is mounted a first connecting device around, and there is a ventilation hole formed at an opening location on the helmet body or the goggle; a ventilation tube, wherein one end of the ventilation tube is connected to the ventilation hole; a PAPR-typed air supplier, connected to the other end of the ventilation tube, conveying external air into the helmet body via the ventilation tube after particulate matters are filtered; and a guiding towel, made of airtight materials, wherein an upper end thereof has a second connecting device, and the second connecting device is able to detachably connect to the first connecting device. When the first connecting device and the second connecting device are connected. A neck of a user wearing the motorcycle helmet is covered around by the guiding towel at least one loop and air inside the helmet body is guided to exhaust through a lower end of the guiding towel.

According to the present invention, the opening location may be at a backside of a top of the helmet body, a place of the helmet body closer to a chin of the user, or one of two sides of the goggle. A ventilation rate of the PAPR-typed air supplier may fall between 60 liter/minute and 100 liter/minute. The second connecting device may be a hook-side of a hook-and-loop fastener or a loop-side of the hook-and-loop fastener. The first connecting device may be a loop-side of a hook-and-loop fastener or a hook-side of the hook-and-loop fastener corresponding to the second connecting device.

Preferably, a material of the guiding towel may be Polypropylene (PP), polyester fiber or melt-blown polypropylene. A material of the guiding towel may also be woven fabric or functional fabric made of elastic cloth and woven fabric. The guiding towel may be externally coated with a layer of waterproofing membrane. The waterproofing membrane may be a Polyethylene (PE) membrane. A length from the upper end to the lower end of the guiding towel may not be shorter than 28 centimeters.

In some embodiments, the PAPR-typed air supplier may be externally connected to a portable secondary battery pack or a locomotive battery as a source of power. After the user puts on the motorcycle helmet, filtered air flown into the helmet body and passed through a head of the user conveys heat to external air through the guiding towel. The guiding towel further comprises a fixing device for fixing the guiding towel to cover around the neck of the user wearing the motorcycle helmet at least one loop. The fixing device may be a set of zippers, a plurality of press buttons or a hook-and-loop fastener.

With the design of the helmet body, the ventilation tube, the PAPR-typed air supplier 30 and the guiding towel 40, filtered clean air can be provided to the users. During ventilation, heat inside the helmet body can be brought out. The goal to make the helmet cool is available.

### BRIEF DESCRIPTION OF THE DRAWINGS

FIG. 1 is a schematic diagram of a motorcycle helmet according to an embodiment of the present invention.

FIG. 2 illustrates a helmet body viewed from the bottom and a guiding towel flatly shown.

FIG. 3 illustrates another guiding towel flatly shown.

FIG. 4 illustrates different aspects of the guiding towels cover around a neck of a motorcycle rider.

FIG. 5 illustrates a location of a ventilation hole and air flow directions.

FIG. 6 illustrates another location of a ventilation hole and air flow directions.

### DETAILED DESCRIPTION OF THE PREFERRED EMBODIMENTS

The present invention will now be described more specifically with reference to the following embodiments.

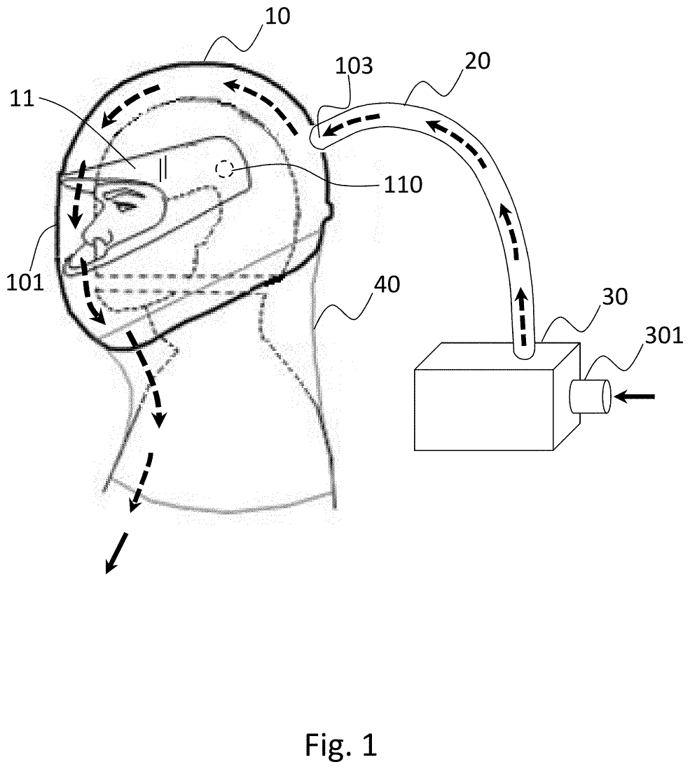

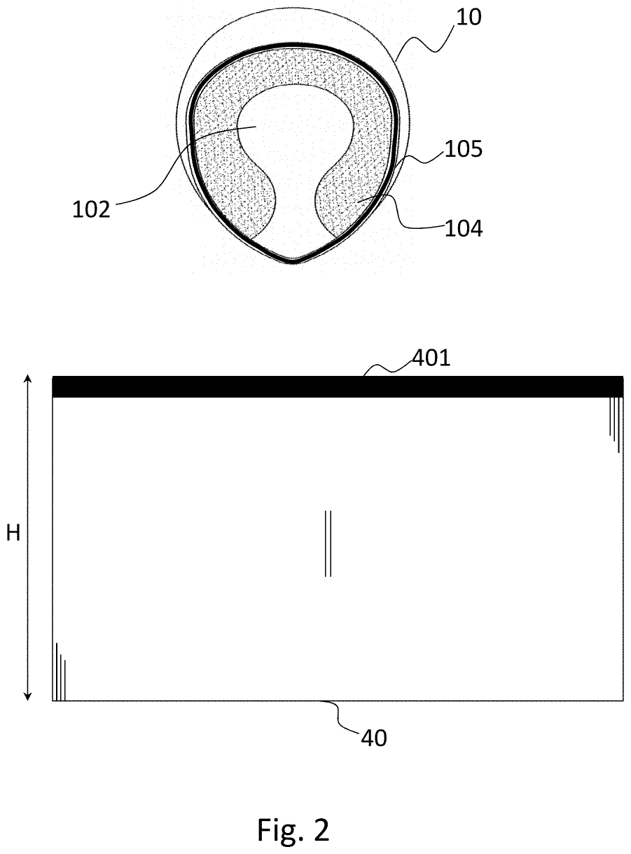

Please refer to FIG. 1 and FIG. 2. FIG. 1 is a schematic diagram of a motorcycle helmet according to an embodiment of the present invention. FIG. 2 illustrates a helmet body 10 viewed from the bottom and a guiding towel 40 flatly shown. The motorcycle helmet disclosed by the present invention includes said helmet body 10, a ventilation tube 20, a PAPR-typed air supplier 30 and said guiding towel 40. The following describes functions, aspects, and interactions of these components.

The helmet body 10 is a main body of the motorcycle helmet to protect safety of the user head. By appearance classification, the motorcycle helmet is full-faced type. Because the key points of the present invention are providing users clean air and taking away the heat come from the head of the motorcycle rider inside the helmet body 10, a portion of the helmet body 10 may be the same as what is used in the prior art and not emphasized by the specification. Hence, the scope of the helmet body 10 may include, but not limit to external anti-friction protection materials, an absorption impact padding, belts, a head wearing opening, a tab, a goggle, goggle fixers, a head cushion, a neck guard, a retaining edge, an ear cushion, etc.

Compared with the cap structure of existing helmets, the helmet body 10 is characterized in that it has a window opening 101, a wearing opening 102, and optionally a ventilation hole 103. Besides, there is no other hole connecting internal space and external environment. Such design is used to effectively isolated air circulation inside and outside of the helmet body 10, further preventing the motorcycle riders from inhaling air with particulate matters not filtered. Two sides of the window opening 101 have a pivotally connecting device 110, respectively (due to perspective issue, only one pivotally connecting device 110 on one side of the window opening 101 is illustrated). The pivotally connecting device 110 can pivotally connected to a goggle 11. The goggle 11 can pivotally rotate to the window opening 101 and seal the window opening 101 (FIG. 1 illustrates that the goggle 11 has pivotally rotated to the window opening 101 and sealed the window opening 101, hence, the goggle 11 and the window opening 101 are physically coincident in appearance). When the goggle 11 rotates away from the window opening 101, air inside and outside of the helmet body 10 can circulate. The wearing opening 102 is used as an opening for the head of the user to enter the helmet body 10. In practice, a portion space of the wearing opening 102 may be occupied by a cushion 104. The wearing opening 102 is mounted a first connecting device 105 around. The first connecting device 105 is a tool to closely connect to the guiding towel 40. Its appearance and detailed functions will be explained in the text below.

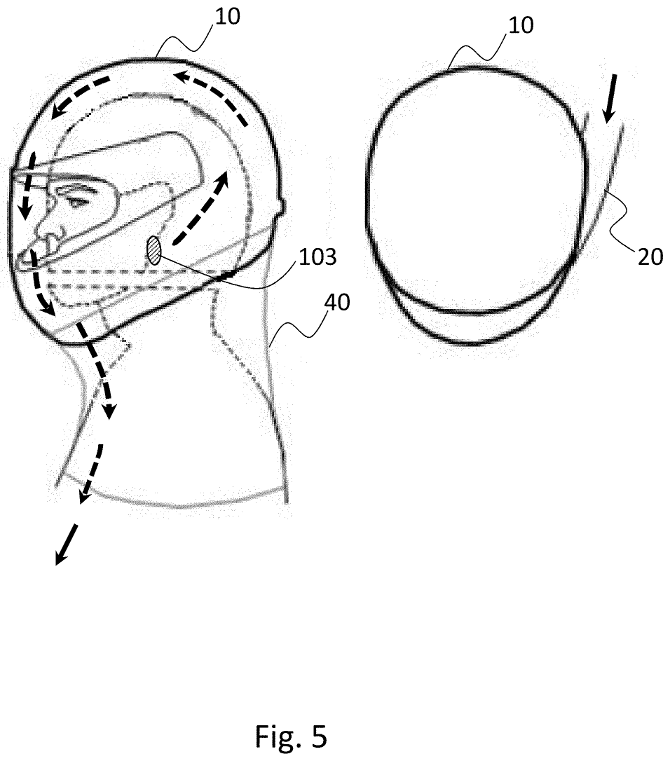

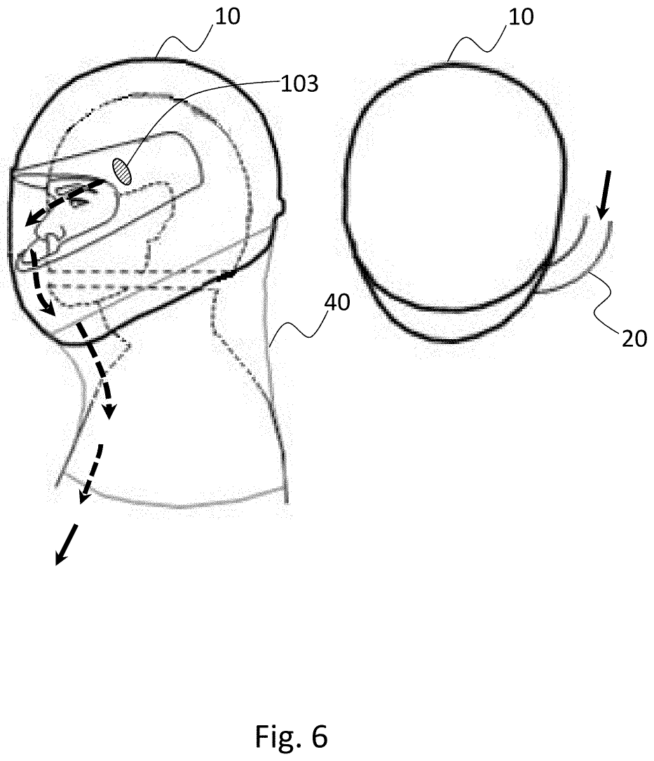

As mentioned above, the ventilation hole 103 of the helmet body 10 is optionally made. If there is no ventilation hole 103 on the helmet body 10, it can be made on the goggle 11. For illustration, a location of the ventilation hole 103 is called as an opening location hereinafter. In the present embodiment, as shown in FIG. 1, the opening location is at a backside of a top of the helmet body 10 (relative to the user's visual direction). According to the present invention, in another embodiment, the opening location cab be at a place of the helmet body 10 closer to a chin of the user (as shown by the location of an oval with oblique lines in FIG. 5); in still another embodiment, the opening location may be at one of the two sides of the goggle 11 (as shown by the location of an oval with oblique lines in FIG. 6). Different opening location will lead to different air circulation inside the helmet body 10. Internal air circulation will be disclosed below.

One end of the ventilation tube 30 is connected to the ventilation hole 103. The other end is connected to the PAPR-typed air supplier 30. Types and materials of the ventilation tube 30 are not restricted. Preferably, is it a hose, e.g. a Poly Vinyl Chloride (PVC) hose or an Ethylene Vinyl Acetate (EVA) hose, so that users can flexibly rotate their heads without being restricted. The PAPR-typed air supplier 30 is an air supply of a Powered Air Purifying Respirator (PAPR). The PAPR is a high-performance particle filtering respiratory protective device, providing air for the wearer to breathe with a portable blower. The blower and batteries are usually mounted on the wearer's belt or a rear end of a helmet. The blower brings the air with contaminants to a high-efficiency filter for filtering particulate matters. If it comes with an adsorption jar, partial gaseous pollutants can be removed at the same time. Generally speaking, the PAPR-typed air supplier 30 may include a host, a high performance filter, a belt, a flow indicator, etc. Detailed structures are not limited by the present invention. However, in order to effectively provide electricity, the PAPR-typed air supplier 30 may be externally connected to a portable secondary battery pack or a locomotive battery (not shown) as a source of power. The function of the PAPR-typed air supplier 30 in the motorcycle helmet of the present invention is to filter particulate matters from the external air and then send the filtered air to inside of the helmet body 10 via the ventilation tube 20. Ventilation rates of the PAPR-typed air supplier 30 are different depending on product brands and specifications. In order to effectively provide clean and cool air while not to cause excessive carbon dioxide (CO2) accumulation in the helmet body 10, after experiments, it is confirmed that the ventilation rate of the PAPR-typed air supplier 30 preferably falls between 60 liter/minute and 100 liter/minute.

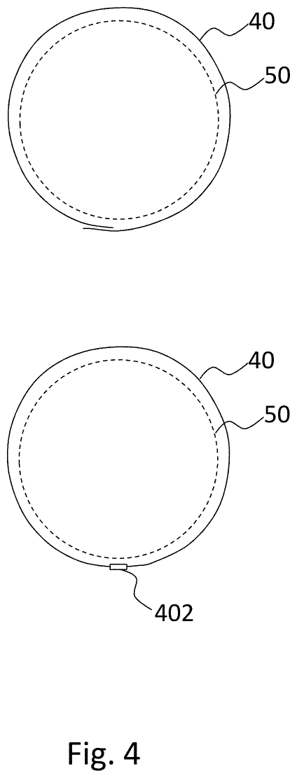

The guiding towel 40 (plane view as illustrated in the bottom of FIG. 2) is made of an airtight material. A top end of the guiding towel 40 has a second connecting device 401. The second connecting device 401 is able to detachably connect to the first connecting device 105. The purpose is that the guiding towel 40 can be mounted on after the user puts on the helmet body 10, in case a fixed guiding towel may be rolled into the helmet body 10. When the first connecting device 105 and the second connecting device 401 are connected, a neck 50 of the user wearing the motorcycle helmet is covered around by the guiding towel 40 at least one loop, as shown by a use state profile in the upper part of FIG. 4. Since there will be a flow of clean air from the helmet body 10 which causes a steady flow, in order to guide the air flow and prevent from dirty air coming from the outside of the helmet body 10, the guiding towel 40 is used to guide the air inside the helmet body 10 is guided to exhaust through a lower end of the guiding towel 40. Meanwhile, external air is isolated for circulation.

In the present embodiment, a plane of the guiding towel 40 is designed to a rectangle. A second connecting device 401 in an upper portion of the guiding towel 40 can be a hook-side of a hook-and-loop fastener or a loop-side of the hook-and-loop fastener. Therefore, the first connecting device 105 is a loop-side of a hook-and-loop fastener or a hook-side of the hook-and-loop fastener corresponding to the second connecting device 401. Namely, if the second connecting device 401 is a loop-side of the hook-and-loop fastener, the first connecting device 105 is a hoop-side of the hook-and-loop fastener; if the second connecting device 401 is a hoop-side of the hook-and-loop fastener, the first connecting device 105 is a loop-side of the hook-and-loop fastener. Because the first connecting device 105 is located on a lower edge of the helmet body 10, by utilizing the hook-and-loop fastener, the guiding towel 40 can be effectively connected to the helmet body 10 and prevent external air from flowing into the helmet body 10.

In the present embodiment, a material of the guiding towel 40 may be Polypropylene (PP) synthetic fiber, e.g. using a neckerchief in the market; a material of the guiding towel 40 may also be Polyester fiber, e.g. using a scarf in the market; a material of the guiding towel 40 may be melt-blown polypropylene, e.g. using a filter in a middle layer of a mask. In addition to petrochemical products, the guiding towel 40 can use natural textiles or mixed textiles. For example, a material of the guiding towel 40 can be woven fabric or functional fabric made of elastic cloth and woven fabric (soft shell). Of course, if poor air tightness is concerned, the guiding towel 40 can be externally coated with a layer of waterproofing membrane, e.g. a polyethylene (PE) membrane. It should be noticed that the length of guiding towel 40, illustrated by H in the lower portion of FIG. 2, should be long enough. This is because the wind speed outside will blow up the guiding towel 40, causing the guiding towel 40 can not effectively block air flow when riding. Based on the observation from experiments, the length of the guiding towel 40 should be at least 28 centimeters. It is able to block air flow when riding. It is to say the length H from the upper end to the lower end of the guiding towel is not shorter than 28 centimeters.

Come back to FIG. 1. After the user puts on the helmet body 10, installs the guiding towel 40 and initiates the PAPR-typed air supplier 30, external air enters the PAPR-typed air supplier 30 via an air inlet 301. After the contaminations and particulate matters are removed by the PAPR-typed air supplier 30, the air then moves along dashed arrows and goes to an upper portion of the helmet body 10 via the ventilation tube 20. After taking away the heat from the user's head, the air then moves to the lower portion of the helmet body 10, along the space between the goggle 11 and the user's face. Next, the air flows out of the helmet body 10 and is guided by the guiding towel 40 downward until it is exhausted to the outside of the guiding towel 40. It is to say that after the user puts on the motorcycle helmet, filtered air flown into the helmet body 10 and passed through a head of the user conveys heat to external air through the guiding towel 40. It achieves the goal of providing cool and clean air to the motorcycle riders. When the weather becomes cold, filtered air can go to a surface of an engine guided by a tube first to increase temperature.

According to the spirit of the present invention, the opening location has other options. The following describes the different aspects. Please refer to FIG. 5. FIG. 5 illustrates a location of a ventilation hole 103 and air flow directions in another embodiment. The left side is a side view of the helmet body 10 while the right side is a top view of the helmet body 10. Since the opening location is close to a chin of the user of the helmet body 10, filtered clean and cool air comes into the helmet body 10 from one side, along the ventilation tube 20. After entering the helmet body 10, the air moves along the side face to the top of the helmet body 10 (hindbrain position). After taking away the heat from the user's head, as the previous embodiment, the air then moves to the lower portion of the helmet body 10, along the space between the goggle 11 and the user's face. Finally, the air flows out of the helmet body 10 and is guided by the guiding towel 40 downward until it is exhausted to the outside of the guiding towel 40. Compared with the previous embodiment, this design needs to destroy the structure of the helmet body 10, and is not suitable for existing helmets to modify.

Please see FIG. 6 again. FIG. 6 illustrates a location of a ventilation hole 103 and air flow directions in still another embodiment. The left side is a side view of the helmet body 10 while the right side is a top view of the helmet body 10. Since the opening location is at one of the two sides of the goggle 11, filtered clean and cool air comes into the helmet body 10 from one side, along the ventilation tube 20. After entering the helmet body 10, the air will not move to the lower portion of the helmet body 10 to take away the heat from the user's head. On the contrary, the air flows to the space between the goggle 11 and the user's face along an eye and a cheek, and then turns to flow to the lower portion of the helmet body 10. Finally, the air flows out of the helmet body 10 and is guided by the guiding towel 40 downward until it is exhausted to the outside of the guiding towel 40. Compared with the previous embodiment, this design has a narrow range of airflow, and the head heat is more easily accumulated. It is suitable for use when riding a motorcycle in winter.

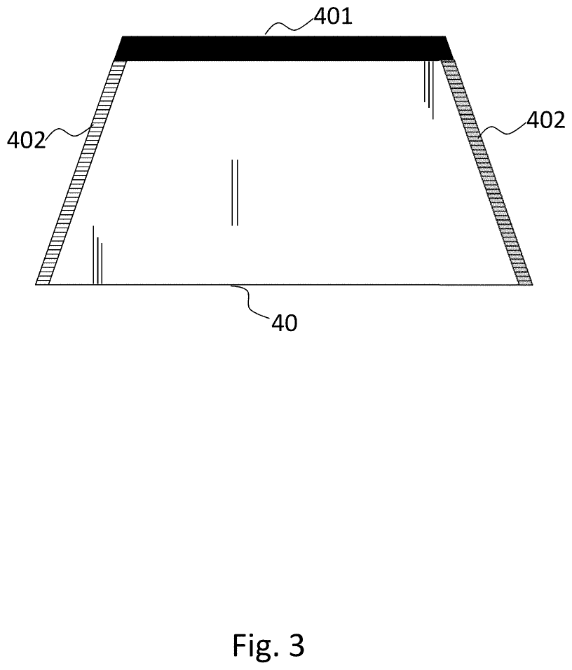

The human body's perimeter is increasing below the neck. If the length H of the guiding towel 40 is designed longer, the guiding towel 40 with a fixed width cannot effectively meet the goal of “a neck of a user wearing the motorcycle helmet is covered around by the guiding towel 40 at least one loop”. Hence, in another embodiment, the width of the guiding towel 40 can be designed to increase from its top to its bottom, as shown in FIG. 3. In order to guarantee that two sides of the guiding towel 40 can effectively be closed, two sides of the guiding towel 40 can add fixing devices 402 to fix the guiding towel 401, ensuring “a neck of a user wearing the motorcycle helmet is covered around by the guiding towel 40 at least one loop” (as shown in the lower portion of FIG. 4). In practice, the fixing device 402 may be a set of zippers, a plurality of press buttons or a hook-and-loop fastener.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A motorcycle helmet providing cool and clean air, comprising:
a helmet body, having a window opening and a wearing opening, wherein two sides of the window opening are pivotally connected to a goggle, the goggle is able to pivotally rotate to the window opening and seal the window opening, the wearing opening is mounted a first connecting device around, and there is a ventilation hole formed at an opening location on the helmet body or the goggle;
a ventilation tube, wherein one end of the ventilation tube is connected to the ventilation hole;
a PAPR-typed air supplier, connected to the other end of the ventilation tube, conveying external air into the helmet body via the ventilation tube after particulate matters are filtered; and
a guiding towel, made of airtight materials, wherein an upper end thereof has a second connecting device, and the second connecting device is able to detachably connect to the first connecting device;
wherein when the first connecting device and the second connecting device are connected; a neck of a user wearing the motorcycle helmet is covered around by the guiding towel at least one loop and air inside the helmet body is guided to exhaust through a lower end of the guiding towel.

2. The motorcycle helmet according to claim 1, wherein the opening location is at a backside of a top of the helmet body, a place of the helmet body closer to a chin of the user, or one of two sides of the goggle.

3. The motorcycle helmet according to claim 1, wherein a ventilation rate of the PAPR-typed air supplier falls between 60 liter/minute and 100 liter/minute.

4. The motorcycle helmet according to claim 1, wherein the second connecting device is a hook-side of a hook-and-loop fastener or a loop-side of the hook-and-loop fastener.

5. The motorcycle helmet according to claim 1, wherein the first connecting device is a loop-side of a hook-and-loop fastener or a hook-side of the hook-and-loop fastener corresponding to the second connecting device.

6. The motorcycle helmet according to claim 1, wherein a material of the guiding towel is Polypropylene (PP), polyester fiber or melt-blown polypropylene.

7. The motorcycle helmet according to claim 1, wherein a material of the guiding towel is woven fabric or functional fabric made of elastic cloth and woven fabric.

8. The motorcycle helmet according to claim 1, wherein the guiding towel is externally coated with a layer of waterproofing membrane.

9. The motorcycle helmet according to claim 8, wherein the waterproofing membrane is a Polyethylene (PE) membrane.

10. The motorcycle helmet according to claim 1, wherein a length from the upper end to the lower end of the guiding towel is not shorter than 28 centimeters.

11. The motorcycle helmet according to claim 1, wherein the PAPR-typed air supplier is externally connected to a portable secondary battery pack or a locomotive battery as a source of power.

12. The motorcycle helmet according to claim 1, wherein after the user puts on the motorcycle helmet, filtered air flown into the helmet body and passed through a head of the user conveys heat to external air through the guiding towel.

13. The motorcycle helmet according to claim 1, wherein the guiding towel further comprises a fixing device for fixing the guiding towel to cover around the neck of the user wearing the motorcycle helmet at least one loop.

14. The motorcycle helmet according to claim 13, wherein the fixing device is a set of zippers, a plurality of press buttons or a hook-and-loop fastener.
